(19) United States
(12) Patent Application Publication
(10) Pub. No.: US 2012/0278691 A1
(43) Pub. Date: Nov. 1, 2012

(54) BUILDING INTERACTIVE DOCUMENTS UTILIZING ROLES AND STATES

(76) Inventors: Ronald Lee Heiney, Harrodsburg, KY (US); Byron S. Pruitt, Lexington, KY (US); Matthew F. Ryavec, Lexington, KY (US); Anastasiya Aleksandrovna Zdzitavetskaya, Lexington, KY (US)

(21) Appl. No.: 13/095,647

(22) Filed: Apr. 27, 2011

(51) Int. Cl. G06F 17/00

(52) U.S. Cl. 715/202

(57) ABSTRACT

In one embodiment, a page of an interactive document and a user interface to enable building of the page are displayed. A designation of an end user role applicable to the document and a designation of a state for the page are received via the interface. A designation of a property is received via the interface, the property to be applied to a component of the page when the page is accessed, in the state, by an end user indentified with the role.

### BACKGROUND

An interactive document is an electronic document that includes embedded instructions and interactive elements to cause document content and/or properties changes as an end user interacts with the document. A designer user can utilize the instructions and interactive elements to create a dynamic document in the style of a form, letter, policy, proposal, memo, or other document type or structure. The interactive document can be created as a template, and customized for the end user's specific set of circumstances based upon that end user's interaction with the document. The interactive document frequently includes a built-in workflow and business rules, and may provide instructional assistance to the end user to expedite the creation or completion of the document via the interactive elements.

### BRIEF DESCRIPTION OF THE DRAWINGS

The accompanying drawings illustrate various embodiments and are a part of the specification. The illustrated embodiments are merely examples and do not limit the scope of the claims. Throughout the drawings, identical reference numbers designate similar, but not necessarily identical elements.

FIG. 1 depicts the physical and logical components of an interactive document build manager according to an embodiment,

FIGS. 2-4 depict example interactive document build services according to embodiments.

FIGS. 5 and 6 are example flow diagrams depicting steps taken to implement various embodiments.

The same part numbers designate the same or similar parts throughout the figures.

### DETAILED DESCRIPTION OF EMBODIMENTS

Creating and modifying an interactive document is frequently a complex task requiring an advanced knowledge of scripting and programming languages. For example, programming languages and scripting with logical operators are often used to dictate interactive document properties based upon conditional logic, e.g., “if/then” statements. As the primary users of the interactive documents are frequently business users that do not have advanced programming skills, enterprises frequently find it necessary to hire programmers to create the interactive documents. Further, modifying an existing interactive document that utilizes scripting and programming languages may require recompilation or redeployment in, or a debugging tool specific to, the language used. These factors add complexity, time and cost to the process of creating and utilizing interactive documents.

Various embodiments described below were developed in an effort to enable users to build electronic interactive documents, without advanced knowledge of programming languages or scripting, utilizing roles and states to dictate conditional logic to be applied to components of the interactive document. As used in this specification and the appended claims, an “interactive document” means an electronic document that includes interactive elements and embedded instructions to cause properties of components to change as an end user interacts with the document. As used in this specification and the appended claims, a “component” of an interactive document means a constituent part or element of the interactive document. In an embodiment, a page of an interactive document and a user interface are displayed to enable a designer user to build the page. A designation of an end user role applicable to the interactive document, a designation of a state for the page, and a designation of a property to be applied to a component of the page are received from the designer user via the user interface. Application of the designated property is to occur when the page is accessed in the state, by an end user that is identified with the role. Utilizing the disclosed method and system, the time and expense associated with building interactive documents is reduced as the documents can be built by users with non-technical backgrounds. Accordingly, entities and individuals will be more likely to create and utilize interactive documents and user satisfaction will increase.

The embodiments shown in the accompanying drawings and described below are non-limiting examples. Other embodiments are possible and nothing in the accompanying drawings or in this Detailed Description of Embodiments should be construed to limit the scope of the disclosure, which is defined in the Claims.

The following description is broken into sections. The first section, labeled “Components”, describes various physical and logical components utilized to implement various embodiments and describes environments in which the embodiments may be implemented. The second section, labeled as “Operation”, describes steps taken to implement various embodiments.

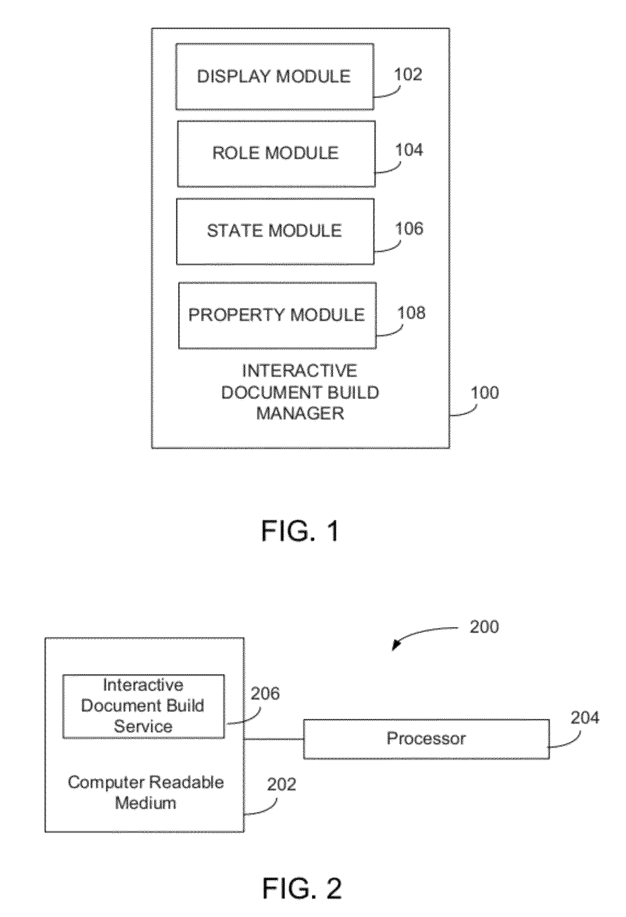

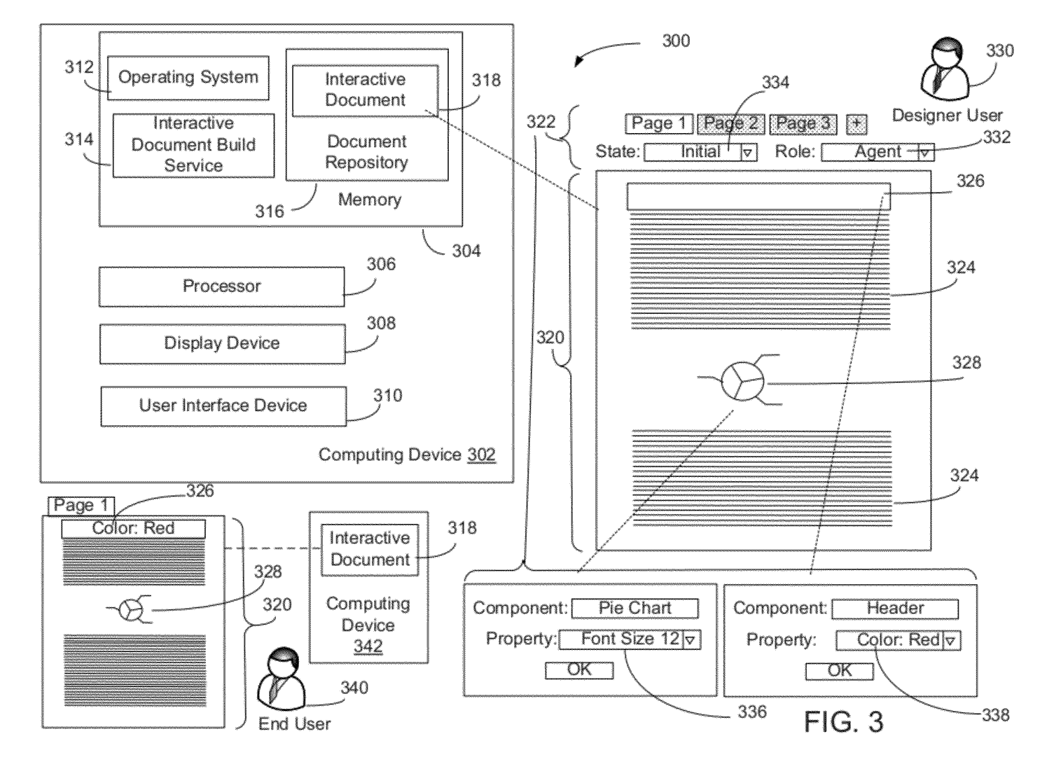

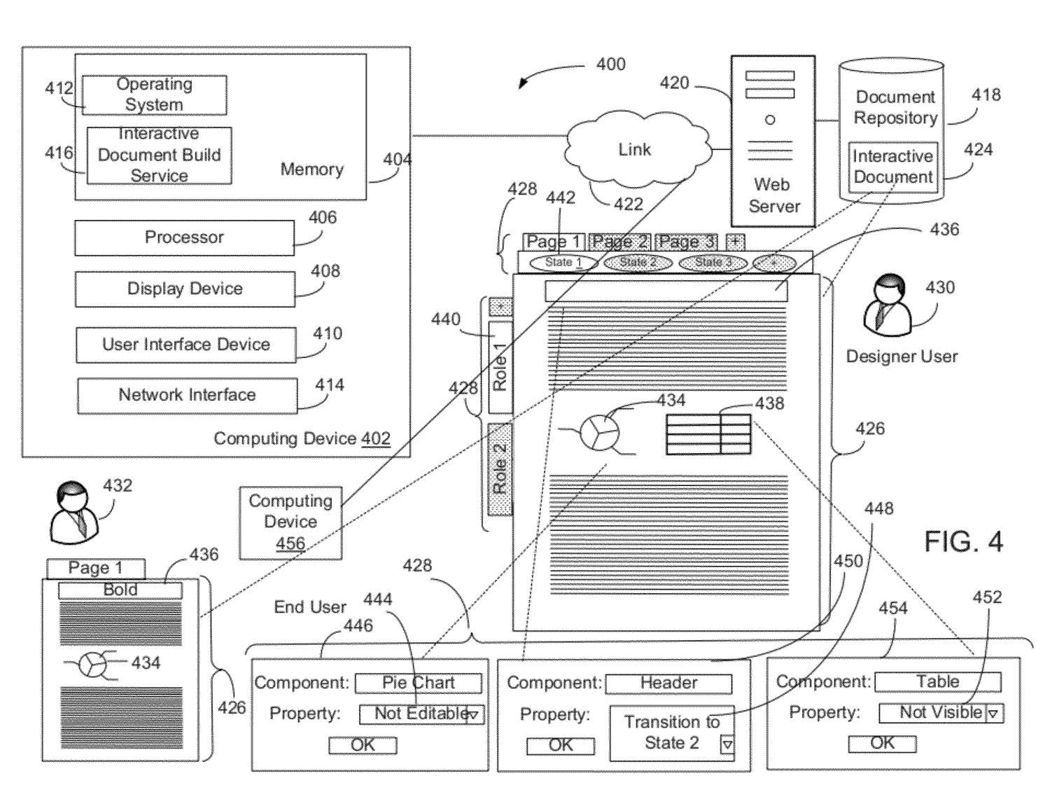

COMPONENTS: FIG. 1 is an example block diagram illustrating the physical and logical components of an interactive document build manager 100. Interactive document build manager 100 represents generally any combination of hardware and programming configured for use to build electronic interactive documents utilizing roles and states. As used in this specification and the appended claims, to “build” an interactive document means to create, develop, or form the interactive document in one or in multiple sessions, and includes making modifications to an existing interactive document. Interactive document build manager 100 may be implemented in a number of environments, such as environment 200 of FIG. 2, environment 300 of FIG. 3 and environment 400 of FIG. 4. In the example of FIG. 1, interactive document build manager 100 is shown to include display module 102, role module 104, state module 106, and property module 108.

Display module 102 represents generally any combination of hardware and programming configured to display a page of an interactive document and a user interface to enable building of the page. For purposes of this specification and the appended claims, “display” means to exhibit or present for perception by a user, and includes but is not limited to visual or tactile display. Display may be visual display via a monitor, a touchscreen, a projection device, or by other means of presenting a visual display of an electronic document. Display may be via tactile display via an electronic Braille display device or other means of presenting a tactile display of an electronic document. As used in this specification and the appended claims, to display a user interface means to display graphics, text or other content, wherein the interface is operable to receive instructions from a user via a user control sequence including, but not limited to, keyboard keystrokes, movements of a computer mouse, or tactile interactions with a touchscreen displaying the user interface.

In an embodiment, the display of the page and the user interface occurs during a design mode. As used in this specification and the appended claims, a “design mode” means a mode, time or period during which the interactive document is being created, generated or modified by a user that is constructing the architecture of the document (a “designer user”), including creating the instructions that define the functional logic for the interactive components. In an example relating to the insurance industry, in a design mode a designer user may create an interactive document to be used, with defined editing rights, by an end user that is an insurance agent in the field.

In embodiments, the design mode display of the page is a preview of what is to be displayed to an end user during a production mode if there are no further changes to the document during the design mode. As used in this specification and the appended claims, a “production mode” means a mode, time or period, separate from the design mode, during which the interactive document is operable to be interacted with by a user (an “end user”) that is using the document for an ultimate intended purpose. Returning to the above insurance industry documentation example, the end user that is an insurance agent in the field can utilize the interactive document in production mode for an intended purpose of creating and/or processing customized insurance applications for the agent's customers. In an embodiment, a production mode end user may have a limited ability to add content, omit content, and or otherwise modify the document during the production mode, to the extent permitted by rules established by the designer user during the design mode.

As used in this specification and the appended claims, a “page” means a portion of the interactive document that is operable to be displayed to an end user. In an embodiment, a page includes the amount or number of components, e.g., text, graphics, and images, that will appear on a single media page if the interactive document is printed by an end user during a production mode. In another embodiment, a page may include the amount or number of components of an interactive document hat will be displayed to an end user in a single view during a production mode.

Role module 104 represents generally any combination of hardware and programming configured to receive from a designer user, via the interface, a designation of an end user role applicable to the document. As used in this specification and the appended claims, “role” means a capacity, position, responsibility, or duty that is defined in relationship to the interactive document. In an embodiment, the interface includes a tab or other role control that, when selected by the designer user via a user control sequence enables the designer user to designate one or more end user roles for the interactive document. For purposes of this specification and the appended claims, a “role control” means a control within the displayed user interface that enables a designer user to designate functionality for a component that is to apply when the component is being accessed by an end user with a specified role.

In an embodiment, the role control includes the text “Role” in a menu style control. Selection by a designer user of “Role” text contained within the menu causes a role designation pop-up window to appear as part of the display. In this embodiment, the pop-up window in turn provides an interface for the designer user to define, assign, or otherwise designate an end user role applicable to the document. In another embodiment, a role control is a tab or other role control located on a menu bar displayed with the interactive document during design mode. Returning to the insurance industry example previously discussed, a designer user could designate “Agent” and “Client” roles to the interactive document, such that display and interactivity of the document are different depending upon whether the end user is identified with the “Agent” or “Client” role.

State module 106 represents generally any combination of hardware and programming configured to receive from a designer user, via the interface, a designation of a state for the page. As used in this specification and the appended claims, a “state” means a condition or status of the interactive document. In an embodiment, the interactive document serves as a container to hold the components (e.g., text fields, graphics, and images) that are included for multiple states of the document. During a production mode display of a page in a particular state, the components' properties applicable to that state are applied. Properties that are not applicable to the components in that state are not applied. In an embodiment, the interface includes a state tab, menu-style control, or other state control that, while selected by a designer user, renders changes to a component applicable to the state represented by the tab or control.

Returning to the insurance industry example previously discussed, a designer user during a design mode may designate multiple states for a page of the interactive document, with the multiple states relevant to a process for effecting a purchase of an automobile insurance policy by an end user. The interactive document may be a web-based document that includes multiple states applicable to different stages of the insurance policy purchase transaction. The interactive document may include a first state that is an informational state for the end user, a second state to solicit and receive input from an end user relevant to the insurance contract, a third state to guide the user through a payment routine, and a fourth state to summarize the concluded insurance transaction. The interactive document is a container that holds all of the components that will be displayed in any of the page's four states.

Property module 108 represents generally any combination of hardware and programming configured to receive from a designer user, via the interface, a designation of a property to be applied to a component of the page when the page is accessed, in the state, by an end user identified with the role. A component may include, but is not limited to a text box, text field, label, chart, diagram, and/or image. A component might also include an interactive control in a document, such as interactive text field, list box, dropdown list, table control or interactive button, which interactive control allows an end user to interact with the document during a production mode. As used in this specification and the appended claims, a “property” of a component means an attribute, quality or feature of the component. For example, properties that might be designated to a text box component may include, but are not limited to visibility, editability, transition, color, font, font size, font style (e.g., bold, italics, etc.), text capitalization, alignment, or line spacing. For purposes of this specification and the appended claims, a “transition” property means a property to cause a transition of a page from a state to a different state in response to detecting an end user interaction with the component.

In an embodiment, the interface includes a component control to enable or facilitate designation of the property to be applied to the component, with the designation being conditional upon the role of an end user accessing the page, and the state that the page is in when accessed. In an embodiment, the user interface includes a state tab or other state control graphic, a role tab or other role control graphic, and a component control graphic. The state control graphic and role control graphic, while activated by the designer, render changes made to the component applicable to the page state represented by the state control when accessed by an end user identified with the role represented by the role control.

Interactive document build manager 100 may be implemented in a number of environments, such as environment 200 of FIG. 2. Environment 200 includes a computer readable medium 202 and a processor 204. In a given implementation, computer readable medium 202 may represent multiple computer readable media and processor 204 may represent multiple processors.

Computer readable medium 202 represents generally any medium that can contain, store, or maintain programs and data for use by or in connection with the instruction execution system. Computer readable medium can comprise any one of many physical media such as, for example, electronic, magnetic, optical, electromagnetic, or semiconductor media. More specific examples of suitable computer-readable media include, but are not limited to, hard drives, random access memory (RAM), read-only memory (ROM), erasable programmable read-only memory, flash drives, compact discs, and digital video discs. In an embodiment, a number of software components are stored in the computer-readable medium 202 and are executable by processor 204. In this respect, the term “executable” includes a program file that is in a form that can be directly (e.g., machine code) or indirectly (e.g., source code that is to be compiled) performed by the processor 204. An executable program may be stored in any portion or component of computer readable medium 202.

Processor 204 represents generally any instruction execution system, such as a computer/processor based system or an ASIC (Application Specific Integrated Circuit) or other system that can fetch or obtain instructions or logic from computer-readable medium 202 and execute the instructions or logic contained therein.

Computer readable medium 202 is shown to include interactive document build service 206. Interactive document build service 206 represents generally any programming, that, when executed, implements the functionality of the interactive document build manager 100 of FIG. 1. In an embodiment, build service 206, when executed by processor 304, is responsible for displaying a page of an interactive document and a user interface to enable building of the page. Build service 206 receives, via the interface, a designation of an end user role applicable to the document, a designation of a state for the page, and a designation of a property to be applied to a component of the page.

Interactive document build manager 100 may also be implemented in an environment such as environment 300 of FIG. 3. Environment 300 includes a computing device 302, which includes a memory 304, a processor 306, a display device 308 and a user interface device 310. In a given implementation, memory 304 may represent multiple memories, and processor 306 may represent multiple processors. In an embodiment, the computing device 302 may include a number of software components that are stored in a computer-readable medium, such as memory 304, and are executable by processor 306.

Memory 304 is shown to include operating system 312, interactive document build service 314, and document repository 316. Operating system 312 represents generally any software platform on top of which other programs or applications such as interactive document build service 314 run. Examples include Linux® and Microsoft® Windows, Document repository 316 represents generally a collection of electronic interactive documents stored in memory 304. In this example, the document repository holds a single interactive document 318, but could hold a plurality of interactive documents.

Interactive document build service 314 represents generally any programming, that, when executed, implements the functionality of the interactive document build manager 100 of FIG. 1. In particular, build service 314, when executed by processor 304, is responsible for displaying a page 320 of an interactive document 318, and a user interface 322 to enable budding of the page. The display may be a visual display via a monitor, a touchscreen, a projection device, or by other means of presenting a visual display of an electronic document as represented by display device 308. In other embodiments, the display may be a nonvisual, e.g., via a tactile display device. The displayed user interface 322 is operable to receive instructions from a user via a user control sequence utilizing user interface device 310. In this example, the display including the page 320 and the user interface 322 occurs during a design mode, and is a preview of what will be displayed to an end user 340 during a production mode if there are no further changes to the page 320 during the design mode. The example page 320 includes components, e.g., text 324, a header 326, and a pie chart 328.

A designation of an “Agent” end user role applicable to the document is received from a designer user 330 via a role control 332 included within the interface 322. In this embodiment, the role control is a drop-down menu type control. In another embodiment, selection by a designer user of “Agent” via the drop down menu causes a role designation pop-up window to appear as part of the display.

A designation of an “Initial” state for the page 320 is received from the designer user 330, via the interface 322. In this embodiment, the interface 322 includes a drop-down menu type state control 334. In another embodiment, the state control may be a state control that, while selected by a designer user, renders changes to a component applicable to the state represented by the control. In an example the designer user 330 during a design mode may designate multiple states for the page 320 of the interactive document 318, with the multiple states relevant to a process to be facilitated by the interactive document 318. In an example, the designer user 330 might also designate “Presentation” and “Post-Presentation” states in addition to the “Initial” state. In this example, the text 324, header 326, and pie chart components 328 are contained within the document's page 320 such that all the components are present in all states but may have different properties (e.g., visibility, editability, formatting) in different page states.

A designation of a “Font Size 12” property is received from the designer user 330, via a first component control 336 that is part of the interface 322. In this example the first component control 336 becomes visible to the designer user 330 when the designer user clicks or otherwise selects the pie chart 328 component via a user control sequence utilizing user interface device 310. The “Font Size 12” property is to be applied to the pie chart 328 component of the page 320 when the page 320 is accessed, in the “Initial” state, by an end user 340 identified with the “Agent” role. A designation of a “Red” property is also received from the designer user 330, via a second component control 338. The “Red” property is to be applied to the header 326 component of the page 320 when the page 320 is accessed, in the “Initial” state, by an end user 340 identified with the “Agent” role. In this example, the second component control becomes visible to the designer user 330 when the designer user clicks or otherwise selects the header 326 component via the user interface device 310. In other embodiments, the first 336 and second 338 component controls could be visible to a designer user throughout a design mode.

Thus the state control, role control and component control of the interface 322 are utilized by the designer user 330 to designate the “Font Size 12” property to be applied to the pie chart 328 component, and of the “Red” property to be applied to the header 326 component. The designer user's 330 designation of the “Font Size 12” and “Red” properties are conditional upon the role of an end user accessing the page, and the state that the page is in when accessed by the end user.

During a production mode the interactive document 318, or a copy of interactive document 318, may be accessed by an end user 340. In this example, the end user 318 accesses page 320 of interactive document 318 via a computing device 342. In different environments, the end user 340 may access document 318, or a copy of the document 318, that is provided to the end user 340 via an email, a media (e.g., a CD or DVD), or a network (e.g., a LAN or internet connection to computing device 342). The “Font Size 12” property is applied to the pie chart 328 component and the “Red” property applied to the header 326 component in response to determining the page is accessed, in the “Initial” state, by the end user 340 that is identified with the “Agent” role. In an example, determining that the page 320 is being accessed by an end user 340 associated with the role “Agent” may include the interactive document 318 receiving role-identifying input from the end user 340 at the beginning of the production mode session. In another example, the role-identifying input from the end user 340 may be received by an application that runs on computing device 342 and serves as an end user interface for interactive document 318 during the production mode.

Interactive document build manager 100 may also be implemented in an environment such as environment 400 of FIG. 4, Environment 400 includes a computing device 402, document repository 418, and web server 420 interconnected via link 422.

Computing device 402 represents generally any computing device capable of sending network requests to and otherwise communicating with document repository 418 and/or web server 420, and is substantially the same as computing device 302 of FIG. 3 except computing device 402 does not include a document repository as does computing device 302 of FIG. 3, computing device 402 includes a network interface 414, and the interactive document build service 416 causes the display of a different embodiment of an interface than the interface 322 caused to be displayed in FIG. 3. The descriptions of the FIG. 3 memory 304, processor 306, display device 308, user interface device 310 and operating system 312 can be applied to the FIG. 4 memory 404, processor 406, display device 408, user interface device 410 and operating system 412.

Network interface 414 represents generally any combination of hardware and programming configured for electronically connecting computing device 402 to link 422. In an embodiment, the network interface 414 may include a network interface card, a network adapter, a network interface controller, and or a LAN adapter. Network requests may be sent and received utilizing a networking protocol, including but not limited to Transmission Control Protocol/Internet Protocol (“TCP/IP”), HyperText Transfer Protocol (“HTTP”), Simple Mail Transfer Protocol (“SMTP”), Extensible Messaging and Presence Protocol (“XMPP”) and/or Session Initiation Protocol (“SIP”).

Document repository 418 represents generally a database or memory, external to computing device 402 that holds interactive document 424. Document repository 418 may be accessible to computing device 402 via electronic link 422, or via link 422 and a web server 420 dedicated to controlling access to document repository 418. Web server 420 represents generally any computing device, or multiple computing devices, capable of receiving and responding to web requests from computing device 402, and communicating with document repository 418, via link 422.

Link 422 represents generally one or more of a cable, wireless, fiber optic, or remote connection via a telecommunication link, an infrared link, a radio frequency link, or any other connectors or systems that provide electronic communication. Link 422 may include, at least in part, an intranet, the internet, or a combination of both. Link 422 may also include intermediate proxies, routers, switches, load balancers, and the like. The paths followed by link 422 between computing device 402, web server 420 and document repository 418 as depicted in FIG. 4 represent the logical communication paths between these devices, not necessarily the physical paths between the devices.

Interactive document build service 416 represents generally any programming, that, when executed, implements the functionality of the interactive document build manager 100 of FIG. 1. In particular, build service 416, when executed by processor 406, is responsible for displaying a page 426 of an interactive document 424, and a user interface 428 to enable building of the page 426. The displayed user interface 428 is operable to receive instructions from a designer user 430 via a user control sequence utilizing user interface device 410. In this example the display of the page 426 and the user interface 428 occurs during a design mode, and is a preview of what will be displayed to an end user 432 during a production mode if there are no further changes to the document during the design mode. The page 426 includes components, e.g., pie chart 434, header 436, and table 438.

A designation of a “Role 1” end user role applicable to the document is received from the designer user 430 via a role control 440 included within the user interface 428. In this embodiment, the role control 440 is a role tab located on a menu bar displayed with the page 426 during a design mode. A designation of a “State 1” for the page 426 is received from the designer user 430, via a state control 442 included within the user interface 428. In this embodiment, the state control 442 is a state tab that, while selected by the designer user 430, renders changes to a component applicable to the state represented by the tab. In this example the designer user 430 during a design mode may designate multiple states for the page 426 of the interactive document 424, with the multiple states relevant to a process or task to be facilitated by the interactive document 424. In this example, the pie chart 434, header 436, and table 438 components are contained within the interactive document's page 426 in all states, but may have different properties in different page states.

A designation of a “Not Editable” property 444 is received from the designer user 430, via a first component control 446 that is part of the interface 428. A designation of a “Transition” property 448 is also received from the designer user 430, via a second component control 450. A designation of a “Not Visible” property 452 is also received from the designer user 430, via a third component control 454. The “Not Editable” property 444 is to be applied to the pie chart 434 component of the page 426, the “Transition” property 448 is to be applied to the header 436 component of the page 426, and the “Not Visible” property 452 is to be applied to the table 438 component of the page 426 when the page is accessed, in the “State 1” state, by an end user 432 identified with the “Role 1” role. Thus the combination of the state control 442, role control 440 and first 446, second 450, and third 454 component controls of the interface 428 facilitate designation of the properties to be applied to components of the page 426. The designation of the “Not Editable” 444, “Transition” 448 and “Not Visible” 452 properties are conditional upon the role identified with the end user 432 accessing the page 426, and the state that the page is in when accessed by the end user.

In this example the first 446, second 450 and third 454 component controls 446, all part of the user interface 428, are pop-up windows that become visible to the designer user 230 when the designer user clicks or otherwise selects applicable component. In other embodiments, the first 446, second 450 and third 454 components may be visible to a designer user throughout the design mode.

During a production mode the interactive document 424, or a copy of interactive document 424, may be accessed by an end user 432. In this example, the end user 432 accesses the interactive document 424 via computing device 456 accessing the document 424 stored at document repository 418. Document repository 418 may be accessible to computing device 456 via electronic link 422, or via link 422 and web server 420 dedicated to controlling access to document repository 418. The “Not Editable” property 444 is applied to the pie chart 434 component, the “Transition” property 448 to the header 436 component, and the “Not Visible” property 452 to the table 438 component in response to determining the page 426 is accessed, in the “State 1” state, by the end user 432 that is identified with the “Role 1” role. In response to detecting an interaction by the end user 432 with the header 436 component, a transition is caused from the “State 1” page state to a “State 2” page state.

In the foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media. Components operating on different devices, then, may utilize different processors and memory media.

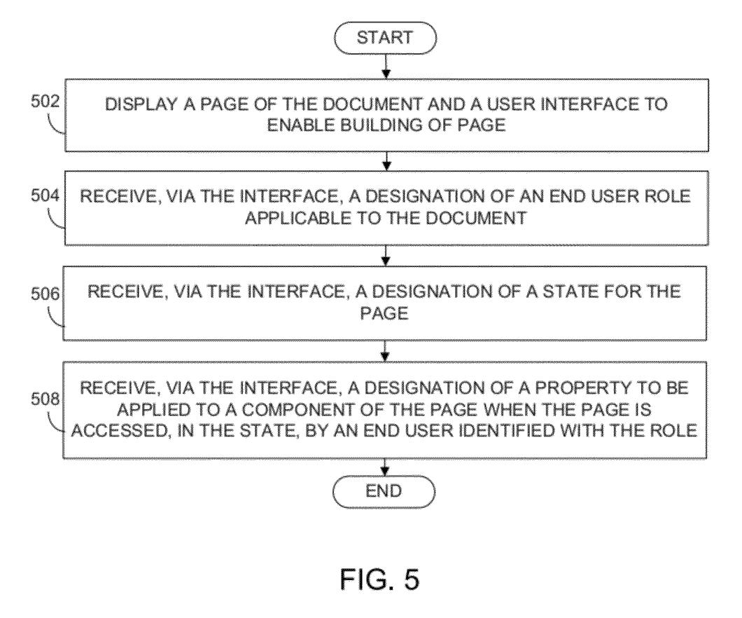

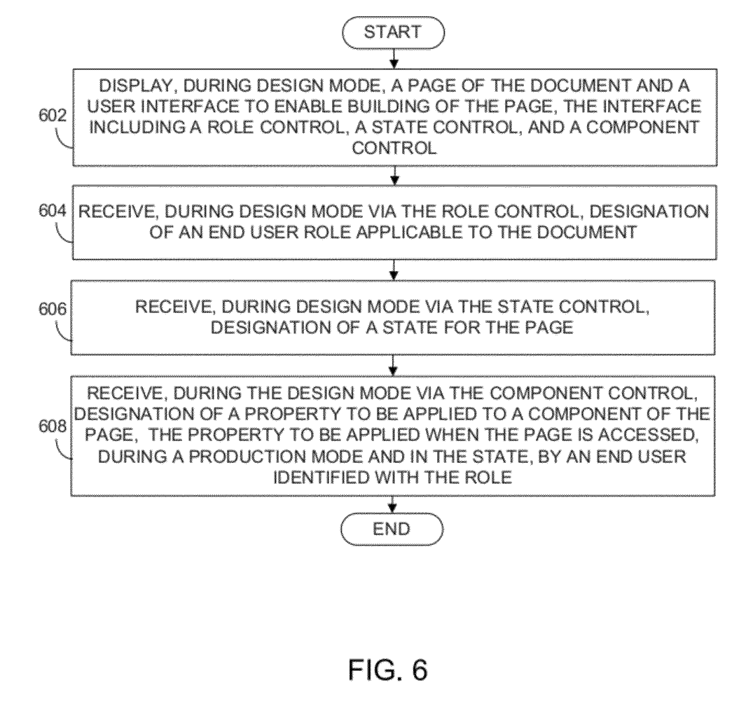

OPERATION: FIGS. 5 and 6 are examples of steps taken to implement various embodiments. In discussing FIGS. 5 and 6, reference may be made to the diagrams of FIGS. 1-4 to provide contextual examples. Implementation, however, is not limited to those examples. FIGS. 5 and 6 depict a workflow from the perspective of an interactive build service such as build service 206 of FIG. 2, build service 314 of FIG. 3, or build service 416 of FIG. 4.

Starting with FIG. 5, a page of the document and a user interface to enable building of the page are displayed (block 502). Referring back to FIG. 1, the display module 102 may be responsible for implementing block 502.

Continuing with the flow diagram of FIG. 5, a designation of an end user role applicable to the document is received via the interface (block 504). Referring back to FIG. 1, the role module 104 may be responsible for implementing block 504.

Continuing with the flow diagram of FIG. 5, a designation of a state for the page is received via the interface (506). Referring back to FIG. 1, the state module 106 may be responsible for implementing block 506.

Continuing with the flow diagram of FIG. 5, a designation of a property to be applied to a component of the page is received via the interface. Application of the property is to occur when the page is accessed, in the state, by an end user identified with the role (block 508). Referring back to FIG. 1, the property module 108 may be responsible for implementing block 508.

Moving on to FIG. 6, a page of an interactive document and a user interface to enable building of the page are displayed during a design mode. The interface includes a role control, a state control, and a component control (block 602). Referring back to FIG. 1, the display module 102 may be responsible for implementing block 602.

Continuing with the flow diagram of FIG. 6, a designation of an end user role applicable to the document is received during the design mode via the role control (block 604). Referring back to FIG. 1, the role module 104 may be responsible for implementing block 604.

Continuing with the flow diagram of FIG. 6, a designation of a state for the page is received during the design mode via the state control (606). Referring back to FIG. 1, the state module 106 may be responsible for implementing block 606.

Continuing with the flow diagram of FIG. 6, a designation of a property to be applied to a component of the page is received during the design mode via the component control. The property is to be applied to the component when the page is accessed, during a production mode and in the state, by an end user identified with the role (block 608). Referring back to FIG. 1, the property module 108 may be responsible for implementing block 608.

CONCLUSION: The diagrams of FIGS. 1-4 are used to depict the architecture, functionality, and operation of various embodiments. Various components illustrated in FIGS. 1-4 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present disclosure may be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein.

Although the flow diagrams of FIGS. 5 and 6 show specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A computer-readable storage medium containing instructions to build an interactive document that, when executed, cause a computer to:
display a page of the document and a user interface to enable budding of the page;
receive via the interface
a designation of an end user role applicable to the document,
a designation of a state for the page,
a designation of a property to be applied to a component of the page when the page is accessed, in the state, by an end user identified with the role.

2. The medium of claim 1, wherein
the display of the page and the interface occurs during a design mode,
the designations of the role, the state, and the property are received during the design mode, and
the application of the property is to occur during a production mode.

3. The medium of claim 1, wherein the properly comprises a transition property.

4. The medium of claim 1, wherein the property comprises at least one of visibility, editability, transition, color, font, or font size.

5. The medium of claim 1, wherein the interface includes a role control that, while selected, renders changes to the component applicable to the role represented by the control.

6. The medium of claim 1, wherein the interface includes a state control that, while selected, renders changes to the component applicable to the state represented by the control.

7. The medium of claim 1, wherein the interface includes a component control to enable designation of a property to a component, the designation conditional upon page state and end user role.

8. The medium of claim 1, further comprising receiving via the interface designations of additional end user roles for the document.

9. The medium of claim 1, further comprising receiving via the interface designations of additional states for the page.

10. A system to build an interactive document, comprising:
a display module, operable to display a page of the document and a user interface to enable building of the page;
a role module, operable to receive via the interface a designation of an end user role applicable to the document;
a state module, operable to receive via the interface a designation of a state for the page;
a property module, operable to receive via the interface a designation of a property to be applied to a component of the page when the page is accessed, in the state, by an end user identified with the role.

11. The system of claim 10, wherein
the display of the page and the interface occurs during a design mode,
the designations of the role, the state, and the property are received during the design mode, and
the application of the property is to occur during a production mode.

12. The system of claim 10, wherein the interface includes a role control that, while selected, renders changes to the component applicable to the role represented by the control.

13. The system of claim 10, wherein the interface includes a state control that, while selected, renders changes to the component applicable to the state represented by the control.

14. The system of claim 10, wherein the interface includes a component control to enable designation of a property to a component, the designation conditional upon page state and end user role.

15. The system of claim 10, wherein the property comprises a transition property.

16. The system of claim 10, wherein the property comprises at least one of visibility, editability, color, font, or font size.

17. The system of claim 10, further comprising receiving via the interface designations of additional end user roles and additional states for the document.

18. A method to build an interactive document, comprising:
displaying, during a design mode, a page of the document and a user interface to enable building of the page, the interface including a role control, a state control, and a component control;
receiving, during the design mode via the role control, a designation of an end user role applicable to the document;
receiving, during the design mode via the state control, a designation of a state for the page;
receiving, during the design mode via the component control, a designation of a property to be applied to a component of the page when the page is accessed, during a production mode and in the state, by an end user identified with the role.

19. The method of claim 18, wherein the property comprises at least one of transition, visibility, editability, color, font, or font size.

20. The method of claim 18, further comprising receiving via the interface designations of additional end user roles and additional states for the document.
